(19) United States
(12) Patent Application Publication
(10) Pub. No.: US 2013/0085973 A1
(43) Pub. Date: Apr. 4, 2013

(54) LIBRARY INTELLIGENCE GATHERING AND REPORTING

(71) Applicant: Talin Ryan Bingham, Wanship, UT (US)

(72) Inventor: Talin Ryan Bingham, Wanship, UT (US)

(73) Assignee: SIRSI CORPORATION, Provo, UT (US)

(21) Appl. No.: 13/275,939

(22) Filed: Oct. 18, 2011

Related U.S. Application Data
(63) Continuation-in-part of application No. 13/249,867, filed on Sep. 30, 2011.

(51) Int. Cl. G06F 17/00

(52) U.S. Cl. 706/45

(57) ABSTRACT

Determining library usage patterns. The method includes accessing information, such as metadata from a plurality of libraries about patron access of physical resources at the libraries. The method further includes accessing information from the plurality of libraries about patron access of electronic resources. The method further includes accessing information about the plurality of libraries. The information is used to determine patron usage of electronic resources and/or physical resources based on library characteristics as determined from the information about the plurality of libraries.

### CROSS-REFERENCE TO RELATED APPLICATIONS

This application is a continuation in part of prior application Ser. No. 13/249,867 filed Sep. 30, 2011, titled “NORMALIZING METADATA BETWEEN LIBRARY CONTENT PROVIDERS”, which is incorporated herein by reference in its entirety.

### BACKGROUND

### Background and Relevant Art

As noted, libraries are able to provide digital content as well as physical content. The libraries will often obtain digital content from digital content publishers on an ad hoc basis.

Additionally, communication mediums and mechanisms that people have used to communicate have changed drastically in recent times. Previously, nearly all individuals would communicate in a fairly private and limited manner, whether by personal visit, mailed letter, or personal phone call. Recently, electronic communications between individuals has resulted in communications from one individual to another being fairly easy to replicate and broadcast to larger audiences. For example, an interpersonal email could be forwarded, with a trivial amount of effort, in a broadcast message to a distribution list comprising a number of other different individuals.

Even more fascinating is communication that takes place using social media. Social media allows people to make statements in the first instance that are generally available to a wide audience. The statements can be made and directed to the wide audience or can be directed to a single individual or group, but accessible by the wide audience. Social media allows individuals to be connected to one another. For example, one individual's wide audience may be her group of friends to which she has selected to be connected. Individuals can be notified (e.g., via email or text message) when others to whom they are connected within a social media environment make statements. Alternatively or additionally, an individual may have a public or semi-public forum where statements may be posted for later review by the public as a whole or by connected individuals respectively.

It is not uncommon for an individual to broadcast, using social media, activities in which the individual is involved or endeavors being undertaken by the individual. For example, an individual may indicate that they are reading a particular book or would like to read a particular book. Persons accessing the individuals broadcast, in some environments, can indicate approval (e.g., by “liking” a broadcast) or disapproval of a particular broadcast.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein is directed to a method of determining library usage patterns. The method includes accessing information, such as metadata from a plurality of libraries about patron access of physical resources at the libraries. The method further includes accessing information from the plurality of libraries about patron access of electronic resources. The method further includes accessing information about the plurality of libraries. The information is used to determine patron usage of electronic resources and/or physical resources based on library characteristics as determined from the information about the plurality of libraries.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an electronic resource acquisition and distribution system;

FIG. 2 illustrates a library usage data acquisition and processing system;

FIGS. 3A-3G illustrate various user interface elements for use in a social media application or web page; and

FIG. 4 illustrates a method of determining library usage patterns.

### DETAILED DESCRIPTION

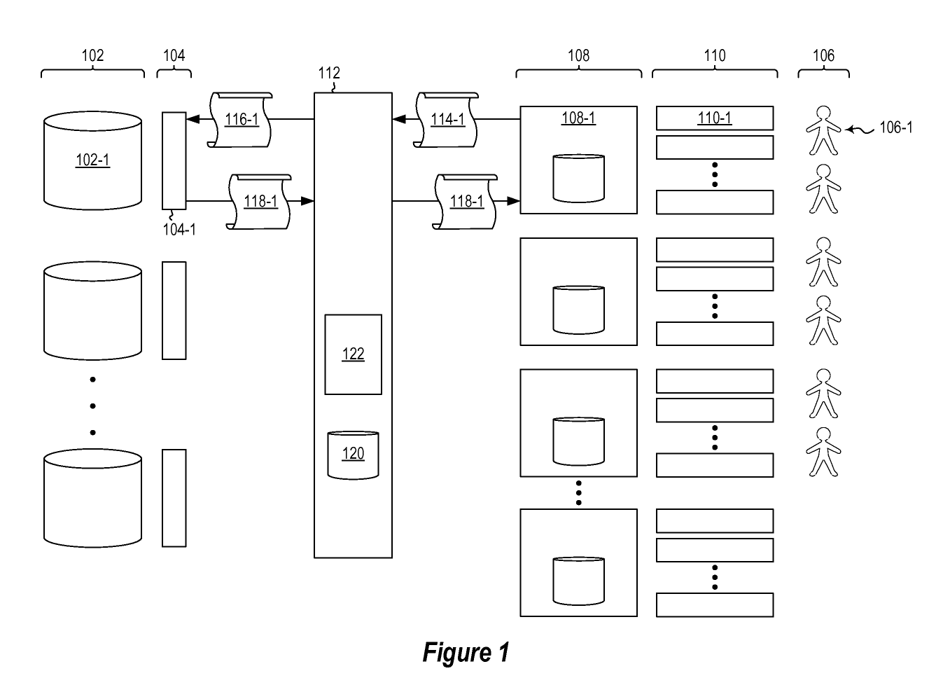

Referring now to FIG. 1, an example is illustrated. FIG. 1 illustrates a set of digital content publishers 102. The digital content publishers 102 provide digital works to consumers of the digital works.

Each of the content publishers provides content using a specific format. In the example shown in FIG. 1, a set of specific publisher interfaces 104 are shown. Each interface for each publisher may be slightly or drastically different from an interface for a different publisher. In addition to the specific publisher interfaces, a publisher may use Machine Readable Catalogue (MARC) interfaces/messages to determine what content is at a particular publisher. MARC messages may provide bibliographic information and related information about works. For example, a MARC message may provide information that may include, for example, title, author, publisher, copyright date, etc.

FIG. 1 illustrates a set of patrons (sometimes referred to herein as users) 106. Patrons are, in some embodiments, the end use consumers of digital and physical content. The patrons may obtain the resources from the publishers 102. Patrons 106 may obtain content from the publishers 102 either directly from the publishers 102 or through an intermediary. If content is obtained directly from the publishers 102, then a patron will likely use a different user interface 104 for each different publisher from which a patron obtains content. For example, each publisher in the set of publishers 102 may have different ways of specifying resources to accessed, different authentication protocols for authorizing a user to access a resource, etc.

Even using certain intermediary models, a patron may still need to use a different user interface for obtaining a resource from a different publisher. For example, FIG. 1 further illustrates a set of integrated library systems (ILSs) 108. Each ILS is associated with one or more interfaces as illustrated by the set of ILS user interfaces 110. Each of the ILS user interfaces in the set of ILS user interfaces determines how a patron will interact with an ILS in the set of ILSs 108. The ILS interfaces may be user interfaces available for different purposes or different user environments. For example, some interfaces in the set of interfaces 110 may be designed for use with a web browser. Other interfaces in the set of interfaces 110 may be designed for use with a stand-alone application such as an “app” on a mobile device or a widget. Still other interfaces in the set of interfaces 110 may be designed for use as portals in an enterprise environment. While a user may be able to consistently use one or more of the interfaces in the set of ILS interfaces 110, a given ILS may direct a patron directly to a publisher in the set of publishers 102 to obtain a given resource. This causes the patron to access a user interface provided by the publisher, which as noted above may vary from one publisher to the next.

However, embodiments may use an intermediary proxy between patrons and publishers which allows patrons to use a consistent interface regardless of the publisher. FIG. 1 further illustrates a centralized electronic resource system 112. The centralized electronic resource system 112 includes the ability to communicate using any one of the interfaces 104. In this way, the centralized electronic resource system 112 can access the publishers 102 and store content from the publishers 102. The centralized electronic resource system 112 can also pass credential information from the patrons 106 thru to the publishers 102. The centralized electronic resource system 112 can present appropriate credentials to the publishers 102 as if the centralized electronic resource system 112 were the patrons 106. The centralized electronic resource system 112 can then pass the resources on to the patrons 106. All of this can be done in a consistent manner which allows patrons to have a consistent user interface to obtain resources irrespective of what publisher is eventually used to obtain resources.

Illustrating now a specific example, a patron 106-1 may send a request 114-1 for an electronic resource 118-1 using an interface 110-1 of an ILS 108-1. The request 114-1 is intercepted by the centralized electronic resource system 112. In some embodiments, the request 114-1 may be in a standard form appropriate for the centralized electronic resource system 112, but that can be sent without respect to the eventual source of an electronic resource (i.e. a publisher). The centralized electronic resource system 112 converts the request 114-1 to a request 116-1 in format and a protocol appropriate for the specific publisher 102.

In some embodiments as outlined below, the centralized electronic resource system 112 is able to convert a request 114-1 to the request 116-1 in an appropriate format and protocol based on normalized metadata. In particular, the centralized electronic resource system 112 may receive metadata from a publisher. The metadata may include specific information about how the publisher can be accessed. This metadata can be normalized such that a request 114-1 can be consistent no matter from what eventual publisher an electronic resource 118-1 is obtained.

In some embodiments, the centralized electronic resource system 112 may act as a proxy for the patron 106-1 or the ILS 108-1. For example, the centralized electronic resource system 112 may receive authentication credentials (e.g., username and password) from the patron 106-1. The centralized electronic resource system 112 may then present these credentials to the publisher 102-1 as if the centralized electronic resource system 112 were the patron 106-1. The publisher 102-1 will then interact with the centralized electronic resource system 112 as if it were the patron 106-1.

The publisher 102-1 returns a resource 118-1 based on the request 116-1. The resource 118-1 can then be sent to the ILS 108-1 and finally to the patron 106-1.

The resource 118-1 can be delivered to the patron 106-1 in one or more of a number of different formats depending on technology at the disposal of the patron 106-1. In particular, the patron may have one or more of a personal computer, an e-book reader, a tablet device, a cell-phone, a handheld electronic device, or other device. The publisher 102-1 may provide the resource 118-1 in a format appropriate for the device(s) available to the patron 106-1. In some embodiments, a patron may be able to register with the centralized electronic resource system 112 what devices the patron 106-1 has. The centralized electronic resource system 112 can then automatically, or at the request of the patron 106-1, obtain a particular format of the resource 118-1 appropriate for the patron 106-1. Alternatively, the patron may be prompted to select an available format from a list of formats provided by the publisher for the specific resource.

In some embodiments, the publisher 102-1 may provide the resource 118-1 in a format based on interaction with the centralized electronic resource system 112. For example, the centralized electronic resource system 112 may request a format that the centralized electronic resource system 112 knows is supported by devices in possession of the patron 106-1. For example, the publisher 102-1 may include protocol features that allow the centralized electronic resource system 112 to specify a particular format. The centralized electronic resource system 112 can use these protocol features to request a particular format of the resource 118-1.

Alternatively, the centralized electronic resource system 112 may act as a proxy for a particular device in possession of the patron 106-1, and receive formats based on what type of device the publisher 102 thinks that it is interacting with irrespective of the actual type of device the publisher 102 is interacting with. In this example, the publisher 102 provides resources in a format based on the type of device with which the publisher 102 believes it is interacting. Thus for example, the publisher may believe that it is interacting with an e-book, and therefore provide a format appropriate for an e-book. Illustratively, the centralized electronic resource system 112 may spoof a user agent appropriate for a particular device in possessions of the patron 106-1. For example, nearly all web browsers specify a user agent when making HTTP requests. The user agent may identify an operating system, browser client and other information. Thus, even though the centralized electronic resource system 112 is not necessarily running a particular operating system, such as a mobile device operating system, the centralized electronic resource system 112 can spoof a user agent that causes the publisher 102-1 to believe that the centralized electronic resource system 112 is running the spoofed operating system. This may cause the publisher 102-1 to deliver the resource 118-1 in a format appropriate for the spoofed user agent to the centralized electronic resource system 112. The resource 118-lean then be delivered to the ILS 108-1 and/or the patron 106-1 in a format appropriate for the patron 106-1.

In some embodiments, the electronic resource 118-1 is returned thru the centralized electronic resource system 112 immediately upon request or very shortly thereafter. However, in other embodiments, the actual electronic resource 118-1 may not be delivered to a patron's device until later. For example, the electronic resource may not be delivered until the patron 106 opens up the appropriate e-book reader or other reader application. For example, in some embodiments, the patron 106 makes the request and the electronic content is effectively “checked out” to the patron 106, but the electronic resource 118-1 itself stays at the publishers database 102-1 until the patron 106 opens their e-book reader or other appropriate software application and does a synchronization process.

The centralized electronic resource system 112 may include functionality for obtaining a plurality of different formats of the electronic resource 118-1 for the patron 106-1. For example, the patron 106-1 may have access to a number of different devices capable of rendering electronic resources. For example, the patron 106-1 may have a smart phone, an e-book reader, a tablet device, a laptop, etc. The centralized electronic resource system 112 can download different formats of the same electronic resource 118-1, one suitable for each device. In particular, each device may have different formatting and/or digital rights management (DRM) schemes. The centralized electronic resource system 112 can obtain, e.g., by direct request or acting as a proxy, different formats of the same electronic resource 118-1 with appropriate formatting and/or DRM protocols.

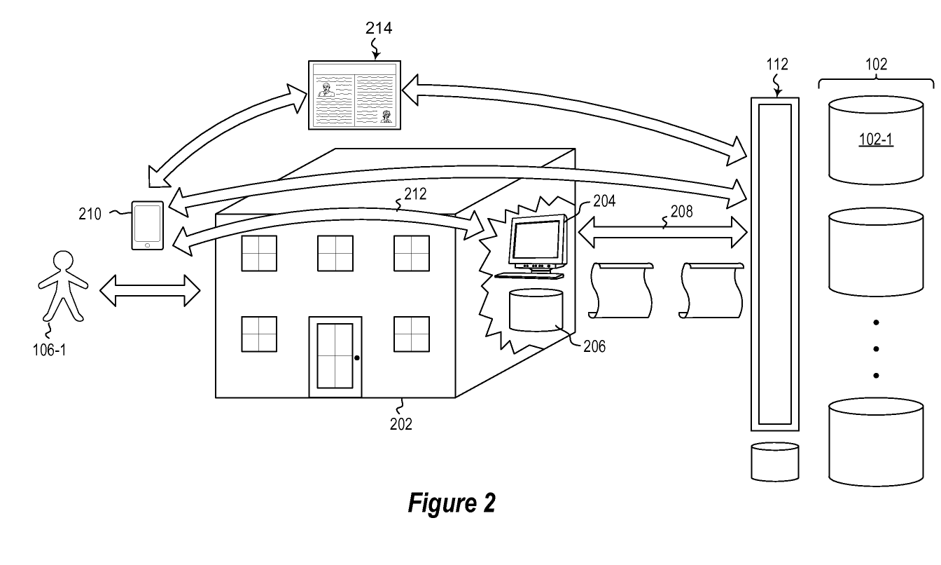

Referring now to FIG. 2 another example is illustrated. FIG. 2 illustrates a physical library 202. The physical library 202 may house a collection of works available for consumption by a patron 106-1. In particular, the patron 106-1 can visit the physical library 202 and read books (or consume other works, such as listen to audio work, or watch video works) at the physical library 202.

When a patron 106-1 consumes a work, the patron's consumption may be tracked. For example, the patron 106-1 may have an account with the library that allows the patron to check works out of the library 202. The account may be tied to a computer record that records information about the patron's consumption of works. For example, FIG. 2 illustrates a check-out system 204. The check-out system is tied to a database 206. The patron 106-1 interfaces with the check-out system 204 to check-out works for later consumption. The database 206 can store information about what works the patron 106-1 has checked out.

Information about what works have been checked out by the patron 106-1 may be stored in one or more of a number of different fashions. For example, information may be stored simply by storing an identifier identifying the work and correlating the identifier to the patron 106-1, such as an ISBN, a UPC, title, title and author, etc. Additionally, in addition to storing and correlating identifiers, some embodiments may be implemented where the database 206 stores additional information about works and/or patrons.

For example, the database 206 may store information identifying a work's genre. Alternatively or additionally, the database 206 may store information identifying a work's publisher. Alternatively or additionally, the database 206 may store information identifying a work's author. Alternatively or additionally, the database 206 may store information identifying a work's publication date. Alternatively or additionally, the database 206 may store information identifying a work's length. Etc.

The database 206 may store information identifying a patron's age. Alternatively or additionally, the database 206 may store information identifying a patron's socioeconomic status. Alternatively or additionally, the database 206 may store information identifying a patron's gender. Alternatively or additionally, the database 206 may store information identifying a patron's relationship to other patrons. Etc.

While the preceding has shown significant amounts of information that can be stored directly by the library 202 on a database 206 under the control of the library (either locally or through a remote service), many embodiments allow much of this information to be generated and/or stored by a third party data processing provider, as will be discussed in more detail below.

In particular, FIG. 2 illustrates a centralized electronic resource system 112. The centralized electronic resource system 112 may be coupled to the check-out system 204. Additionally or alternatively, the check-out system 204 may be coupled to a number of different check-out systems for different libraries. In this way, the centralized electronic resource system 112 can act as a centralized point for receiving, storing and/or generating information related to resource usage at different libraries.

Illustratively, the check-out system 204 may send information to the centralized electronic resource system 112 regarding works checked out from the library 202 by patrons 106 (see FIG. 1). For example, in some embodiments, the check-out system may simply send a message indicating that a particular patron 106-1, identified by a unique identifier such as a customer number, checked out a work, also identified by a unique number such as an ISBN. The centralized electronic resource system 112 may already have additional information about a patron associated with a particular identifier and/or information about a particular work associated with an identifier. The information sent by the check-out system along with information already known by the centralized electronic resource system 112 may be used to create work consumption profiles. In particular, characteristics of patrons, either individually or collectively, can be correlated to characteristics of works, either individually or collectively.

It should be noted that a patron 106-1 may obtain electronic resources from a publisher with a library 202 acting as an intermediary. In particular, an ILS 108-1 (FIG. 1) may be associated and controlled by the library 122. For example, in some embodiments, the ILS 108-1 may be integrated directly into the check-out system 204 or some other system at the library 202 which the user can access directly or indirectly to request electronic resources from publishers 102.

A patron 106-1 can request electronic resources as a patron of the library 202 in one or more of a number of different ways. For example, in one embodiment, the patron 106-1 may physically enter the library 202 and interact with the check-out system 204 which is interconnected with the centralized electronic resource system 112 through communication path 208. The communication path may be any suitable communication path. Some example include, but are not limited to, a public network such as the Internet or public telephone networks, private dedicated LANs or WANs, direct connections such as USB, serial bus, or parallel bus connections, or any other suitable interconnection.

In an alternative embodiment, the patron 106-1 may use a personal electronic device 210 to access the check-out system 204 through the communication path 212, which in turn requests resources from the centralized electronic resource system 112 through the communication path 208, which in turn requests resources from the publishers 102 through an appropriate communication path. The personal electronic device may be one or more of a number of devices such as an e-book reader, a cellular telephone, a tablet computing device, a laptop, a desktop, or other device. The communication path 212 may be any suitable communication path. Some example of mediums that such a path may include, but are not limited to, a public network such as the Internet or public telephone networks, private dedicated LANs or WANs, direct connections such as USB, serial bus, or parallel bus connections, or any other suitable interconnection.

In addition to being a patron of the library 202, a patron may participate in social media communications. Social media allows people to make statements in the first instance that are generally available to a wide audience. The statements can be made and directed to the wide audience or can be directed to a single individual or group, but accessible by the wide audience. Social media allows individuals to be connected to one another. For example, one individual's wide audience may be her group of friends to which she has selected to be connected. Individuals can be notified (e.g. via email or text message or other social media communication mechanisms such as a Twitter Tweet or Facebook notification) when others to whom they are connected within a social media environment make statements. Alternatively or additionally, an individual may have a public or semi-public forum where statements may be posted for later review by the public as a whole or by connected individuals respectively.

It is not uncommon for an individual to broadcast, using social media, activities in which the individual is involved or endeavors being undertaken by the individual. For example, an individual may indicate that they are reading a particular book or would like to read a particular book. Persons accessing the individuals broadcast, in some environments, can indicate approval (e.g., by “liking” a broadcast) or disapproval of a particular broadcast.

Some embodiments may allow interconnections between a patron 106-1, their social media account, and a library 202 to which the patron 106-1 is a patron. These embodiments may allow, for example, a patron to indicate that they are consuming or have consumed a work, and that they obtained the work from a particular library. Additionally, a patron's “friends” on the social networking account can comment or “like” the patron's consumption of the work. The social networking account may be connected to the library (or the libraries delegate), allowing the library to gather additional information about other patrons who may be interested in certain works or characteristics of patrons interested in certain work.

Further details are now illustrated. FIG. 2 illustrates a patron 106-1 using an electronic device 210. The electronic device 210 allows the patron 106-1 to connect to a social media account represented at 214. The social media account may be hosted by a social media provider, such as Facebook of Palo Alto, Calif. Alternatively, in some embodiments, the social media account may be hosted partly by a social media provider and partly by another service provider.

Social media providers may include programming APIs that allow developers to create applications or “apps” within the social media environment. In the example illustrated in FIG. 2, a social media application may be configured to interact with the centralized electronic resource system 112, which in turn can interact with the library 202 (such as through the check-out system 204). Additionally, the application can be interacted with by the patron 106-1 using an interface for the social media account 214 using the electronic device 210.

Using the social media account and an application implemented therein, patrons can manage their library account, search a library catalog, place holds, pay fines, see usage statistics, download eBooks from publishers 102, etc., all within the social media interface. Additionally, embodiments may be able to automatically provide user interface elements to a patron allowing the patron to select works to comment on or to indicate that the patron has read.

For example, centralized electronic resource system 112 can provide to a social media system a listing of works consumed by the patron 106-1. This information can be associated with the patron's social media account 214 using an application developed for the social media system. The patron 106-1 can interact with an interface that is part of the application developed for the social media system. This may allow the patron 106-1 to select works that the patron 106-1 has consumed from the library 202 to allow the patron 106-1 to broadcast on their social media account 214 that they have consumed the selected works. Alternatively, the application may automatically add the works to the patron's social media broadcast information. In some embodiments, whether the information is automatically broadcast or requires user interaction may be dependent on privacy or other settings.

The patron 106-1 may add further information, such as commentary on consumed works and the like. “Friends” of the patron 106-1 may interact with broadcasts on the patron's 106-1 social media account 214. For example, other individuals may “like” or “dislike” a message about a consumed work. Alternatively or additionally, individuals may comment on a message about a consumed work. Interactions with messages about works consumed from the library 202 may be stored and later used for various purposes. For example, if individuals who comment on and/or “like” a work are also patrons of the library 202, the application developed for the social media system may determine if those individuals have already consumed the work from the library 202. If they have not, the application can provide interface elements to allow them to reserve or obtain (such as by mail deliver or download delivery from the publishers 102) a copy of the work.

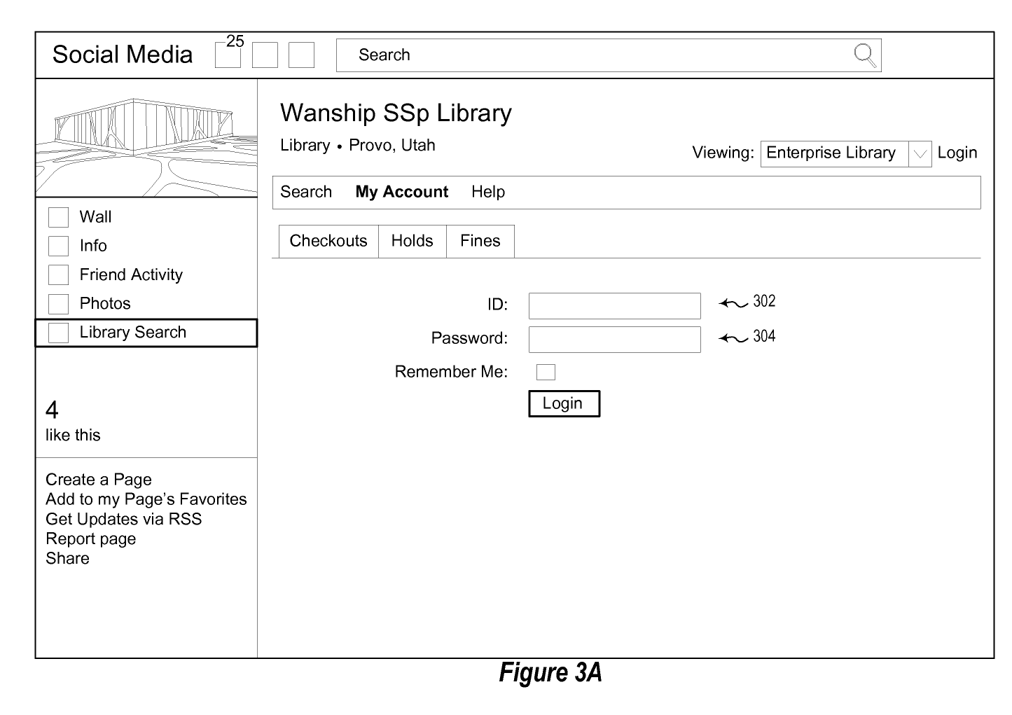

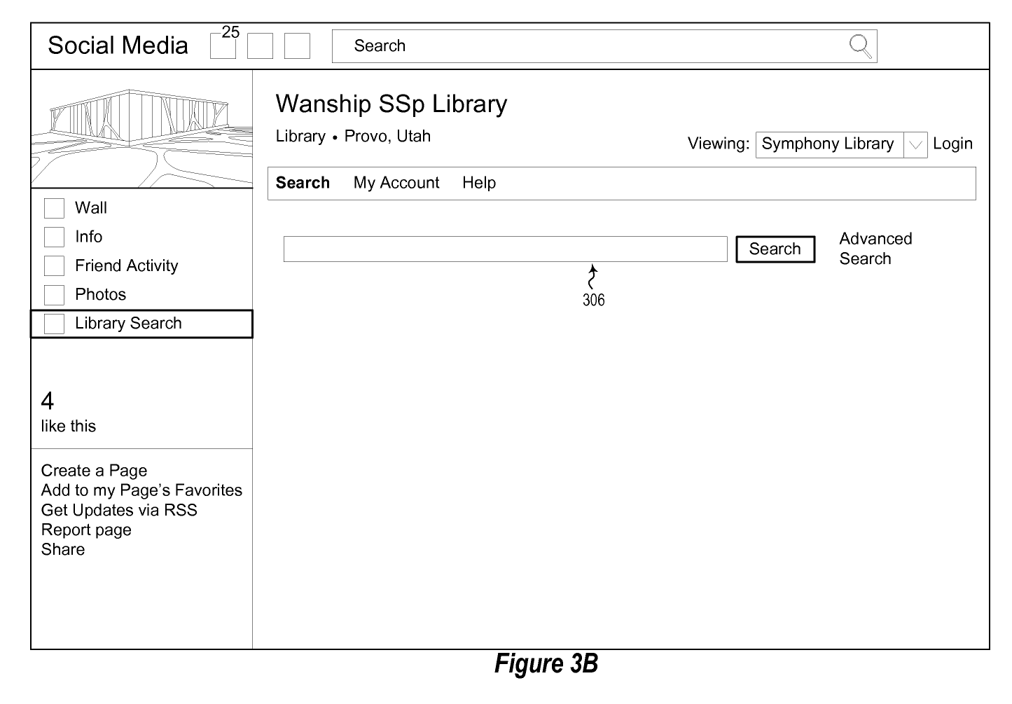

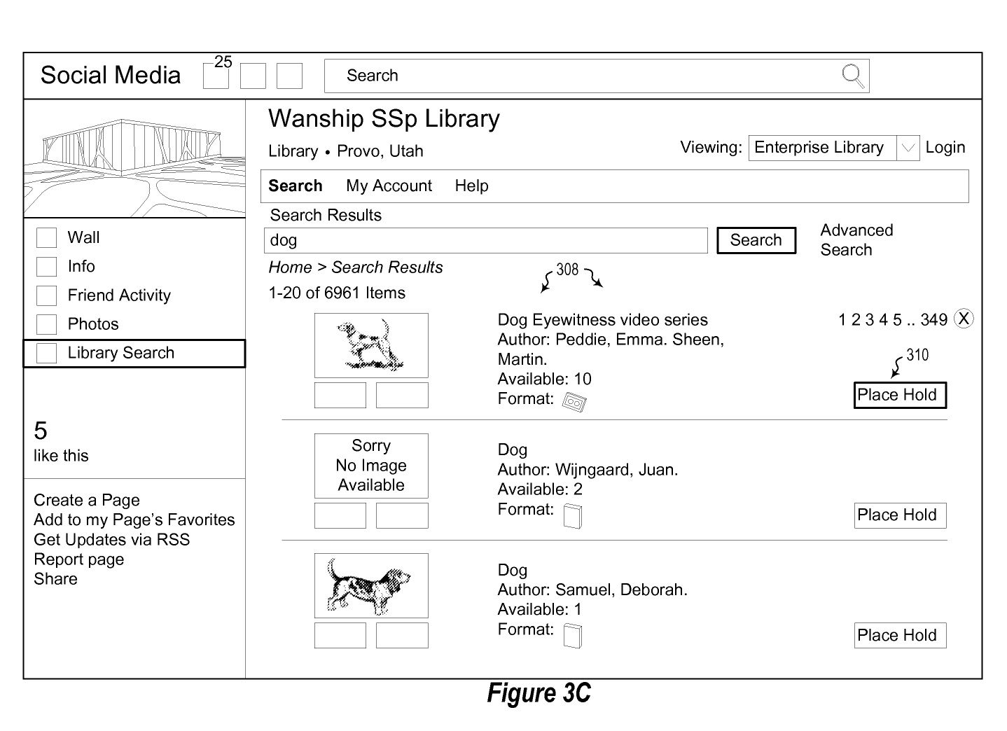

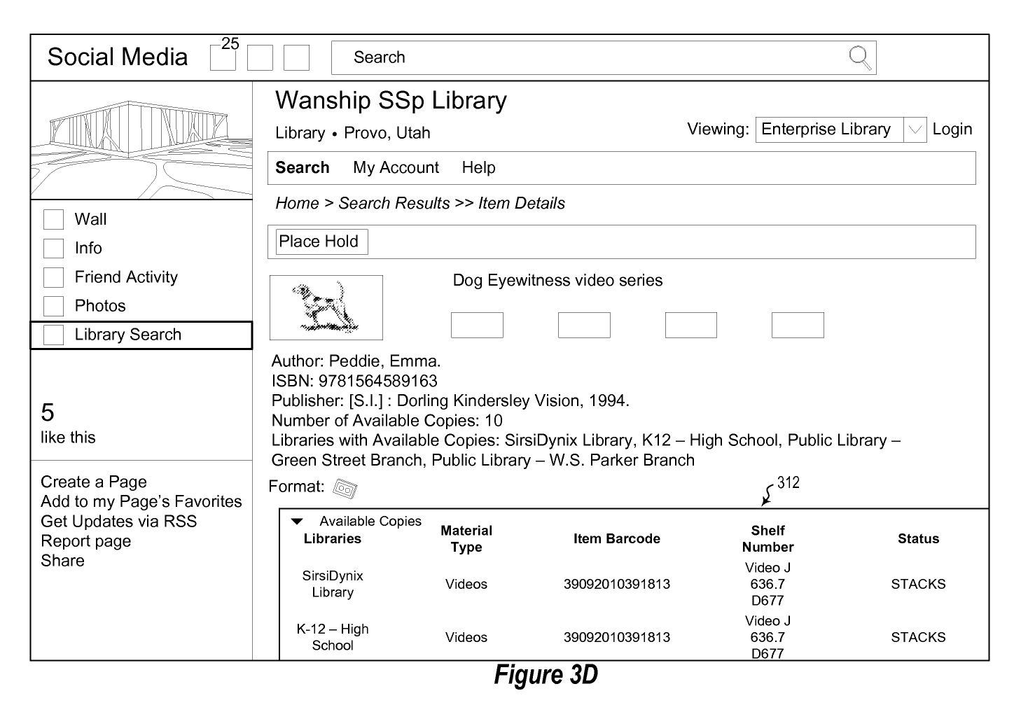

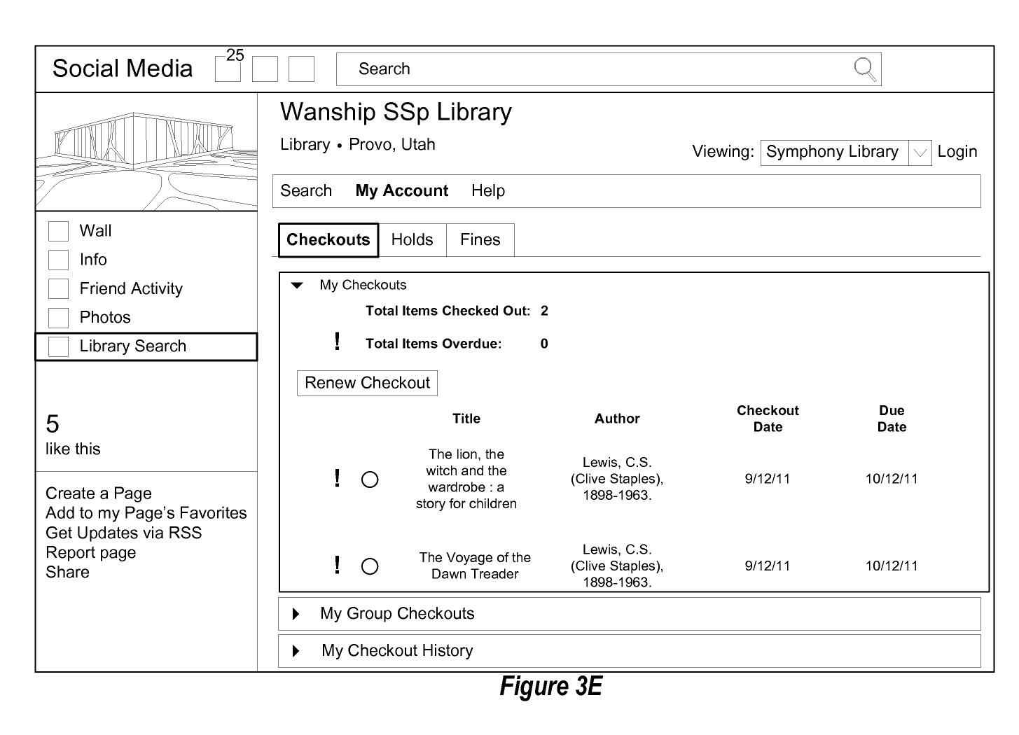

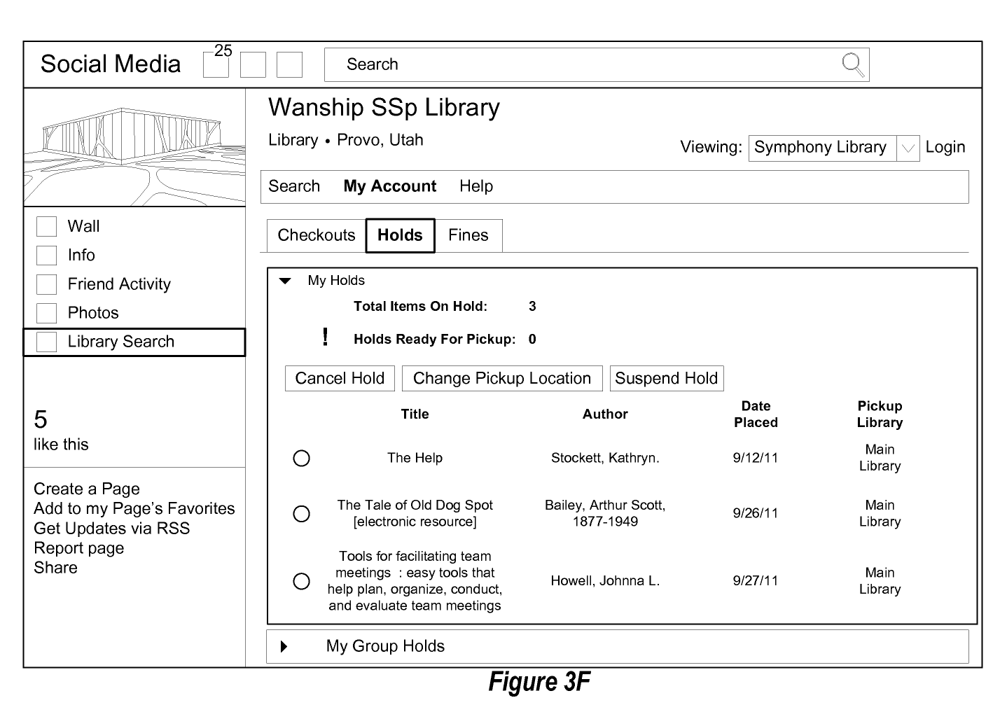

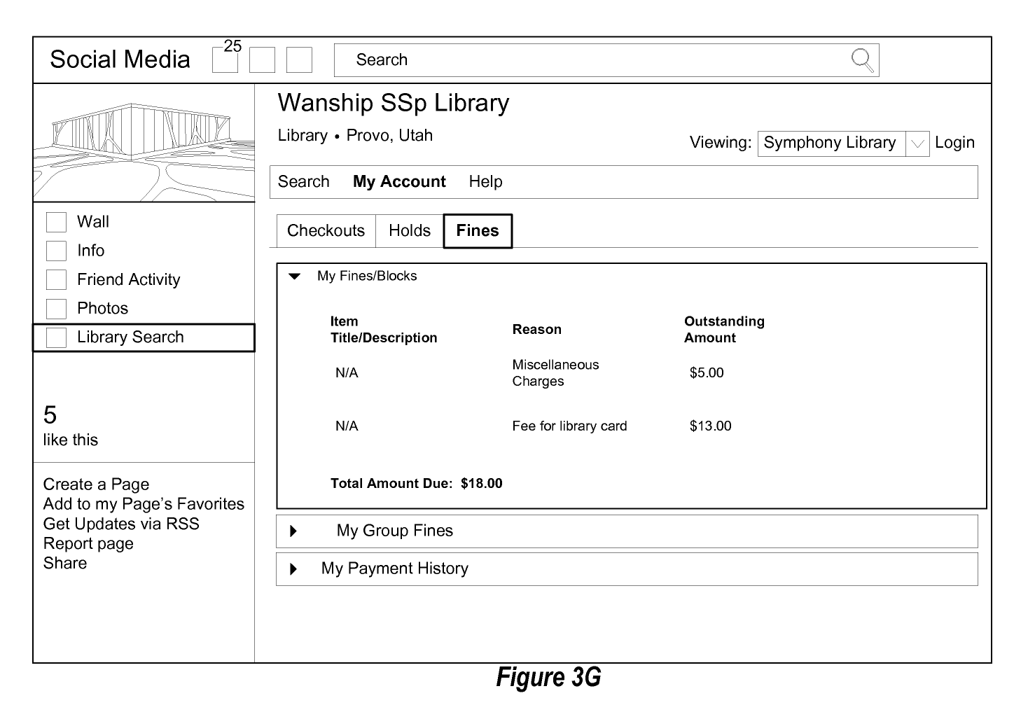

Referring now to FIGS. 3A-3G a social media application interface is illustrated. FIG. 3A illustrates an app interface within a social media application or page. The app interface includes a user ID interface 302 and a password interface 304 that allows a user to log into a library account.

FIG. 3B illustrates a search interface 306 that allows a user to search for various digital or physical works. For example, FIG. 3 C illustrates the results 308 of a search for the word “dog”. The results 308 are illustrated, in the present example, in a list form illustrating work information, as well as availability and formats available. Here a user can share comments and/or like a work which may be shared with their social media account and placed on a social media page, wall, tweet, etc. Using a user interface element 310, a user can place a hold on a work to reserve the work for the user, which the user can physically retrieve at another time.

A user can select a particular work from among the results 308 to see additional information about the work. FIG. 3D illustrates an example of where a work has been selected. Additional information may be included, for example, information describing libraries and locations in libraries where the work may be obtained.

As noted, an application may include functionality for account management. FIG. 3E illustrates an account management user interface showing items checked out to a user. Here a user can evaluate checked out works and even renew a checkout. Users can also view their checkout history and other related information. FIG. 3F illustrates a holds user interface showing holds on works for a user. Here a user can view holds, cancel holds, change pickup locations for a held work, suspend a hold, etc. FIG. 3G illustrates an example of account management for a user. Here a user can view fines owed, renewal fees, or other data related to a user account. In some embodiments, the application may include functionality that allows the user to pay account balances on-line using credit card processing or other money transfer mechanisms.

The following illustrates various features and alternatives that may be implemented in a social media application used in some embodiments.

In some embodiments, a social media application may be a tablet or phone application available from a device app store.

In some embodiments, the application may provide access to physical library information. For example, the application may provide contact information, such as phone numbers, addresses, email numbers, web site addresses, etc. Alternatively or additionally, the application may provide maps and/or directions to the library.

In some embodiments, the application may provide access to circulation desk functionality. For example, using the application, a user may be able to perform searches, place holds, re-checkout books, etc. Embodiments may be implemented where check-out functionality can be performed using books by mail functionality. For example, using the application, books can be checked out using the application, and later delivered by mail or other delivery means.

In some embodiments, the application may provide access to account information. For example, patrons may be able to use the application to access an account, including information and functionality related to viewing and/or taking care of fines and renewals.

In some embodiments, the application may provide access to reading lists. For example, the application may be able to provide access to reading lists created by other and shared on a social network. Alternatively or additionally, the application may be able to generate a reading list based on what “friends” of the patron are reading.

In some embodiments, the application may provide a search bar for searching from any website.

The following now illustrates various features of various embodiments of systems that may be implemented in some embodiments of the invention. For example, by being able to determine patron usage of resources, libraries can more effectively analyze how to better serve their customers and raise more money in the community. Embodiments may be able to provide a customizable dashboard of a library's activities, operations and trends. Embodiments may be able to perform on-the-fly calculations of usage and to analyze various “what-if” scenarios. Embodiments may be able to use determined usage information to automate report distribution.

Some embodiments may implement a zero-footprint web client that requires little to no processing space and can be accessed from anywhere there is an available and suitable network connection to provide the functionality described above. Using a web client, or other portable application, various features can be realized. For example, a library can save money by making staff more efficient by doing certain process on a mobile device, rather than requiring the staff to have direct access to a desktop computing device. Using a portable application allows for embodiments to implement portable circulation and inventory functionality. Portable (or other) embodiments may include online and offline modes. Portable embodiments, may be useful for bookmobiles and outreach services.

Some embodiments may implement functionality using web services and an API (application programming interface) library. This would allow developers and/or end users to build their own applications or customize a system to meet their unique needs. Further, this would allow for embodiments to easily pass data to and from various products.

Embodiments may allow libraries to save money on labor expenses through inbound and outbound phone and voice automation. Embodiments may enable patrons to check library hours, renew materials, check item status, update account information, etc. Embodiments may eliminate major mailing costs and free up staff time for responsibilities and services only they can provide.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

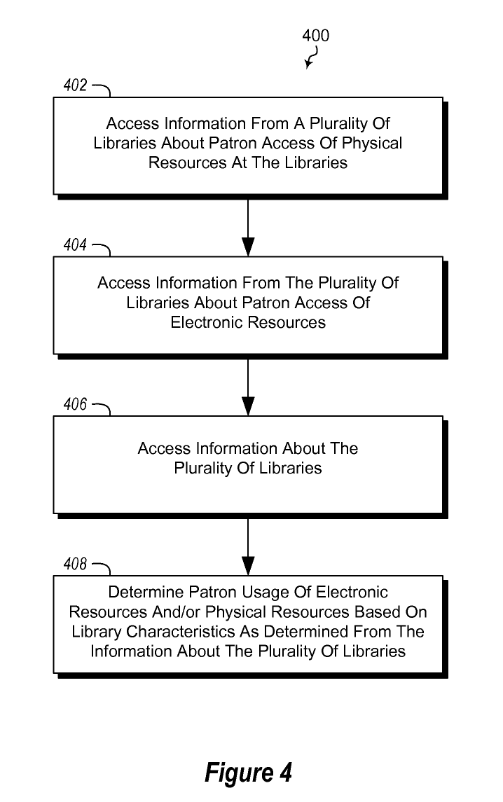

Referring now to FIG. 4, a method 400 is illustrated. The method 400 may include acts for determining library usage patterns. The method includes accessing information (metadata) from a plurality of libraries about patron access of physical resources at the libraries (act 402). For example, as illustrated in FIG. 2, the centralized electronic resource system 112 may receive through communication path 208 information from the check-out system 204 of the library 202 about works accessed by patrons of the library 106. Similar information may be received from other libraries.

The method 400 further includes accessing information from the plurality of libraries about patron access of electronic resources (act 404). For example, the centralized electronic resource system 112 may access information about works delivered to patrons 106 from the publishers 102.

The method 400 further includes accessing information about the plurality of libraries (act 406). For example, information may be collected about various libraries, such as library 202 and other libraries. Such information may include information about, location, language, socioeconomic characteristics of patrons, etc.

The method 400 further includes determining patron usage of electronic resources and/or physical resources based on library characteristics as determined from the information about the plurality of libraries (act 408). For example, information can be generated about what demographics consume what works, about what works a particular individual might be interested in, or other information.

Embodiments of the method 400 may be practiced where library characteristics comprise information about the library type. For example, information may be collected which classifies a library as one or more of a university library, a public library, a corporate library, a government library, a law library, etc.

Embodiments of the method 400 may be practiced where library characteristics comprise information about the library location. For example, embodiments may collect information regarding one or more of a country, state, county, city, street, etc. where a library is located.

Embodiments of the method 400 may be practiced where library characteristics comprise information about the library size. For example, embodiments may collect information regarding the number of works physically housed by the library and/or available through interlibrary loan programs from the library.

Embodiments of the method 400 may be practiced where library characteristics comprise information about library patron language.

Embodiments of the method 400 may be practiced where library characteristics comprise information about library demographics. Library demographics may include information about languages spoken by library patrons. Library demographics may include information about library patron income levels. Library demographics may include information about library patron age. Library demographics may include information about library patron gender. Library demographics may include information about library patron household size. Etc.

Embodiments of the method 400 may be practiced where determining patron usage comprises linking access based relationships between different patrons. For example, linking may be done by linking known family members or by linking known members of a social network. For example, in some embodiments, the relationship is determined based on a patron liking a post on a social media environment by the other patron.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of determining library usage patterns, the method comprising:
accessing information from a plurality of libraries about patron access of physical resources at the libraries;
accessing information from the plurality of libraries about patron access of electronic resources;
accessing information about the plurality of libraries; and
determining patron usage of electronic resources and/or physical resources based on library characteristics as determined from the information about the plurality of libraries.

2. The method of claim 1, wherein library characteristics comprise information about the library type.

3. The method of claim 1, wherein library characteristics comprise information about the library location.

4. The method of claim 1, wherein library characteristics comprise information about the library size.

5. The method of claim 1, wherein library characteristics comprise information about library patron language.

6. The method of claim 1, wherein library characteristics comprise information about library demographics.

7. The method of claim 6, wherein library demographics comprises information about library patron language.

8. The method of claim 6, wherein library demographics comprises information about library patron income levels.

9. The method of claim 1, wherein determining patron usage comprises linking access based relationships between different patrons.

10. The method of claim 9, wherein the relationship is determined based on a patron liking a post on a social media environment by the other patron.

11. In a digital or mixed digital and physical library environment, a computer readable medium comprising computer executable instructions that when executed by one or more processors cause one or more processors to perform the following:
accessing information from a plurality of libraries about patron access of physical resources at the libraries;
accessing information from the plurality of libraries about patron access of electronic resources;
accessing information about the plurality of libraries; and
determining patron usage of electronic resources and/or physical resources based on library characteristics as determined from the information about the plurality of libraries.

12. The computer readable medium of claim 11, wherein library characteristics comprise information about the library type.

13. The computer readable medium of claim 11, wherein library characteristics comprise information about the library location.

14. The computer readable medium of claim 11, wherein library characteristics comprise information about the library size.

15. The computer readable medium of claim 11, wherein library characteristics comprise information about library patron language.

16. The computer readable medium of claim 11, wherein library characteristics comprise information about library demographics.

17. The computer readable medium of claim 16, wherein library demographics comprises information about library patron language.

18. The computer readable medium of claim 11, wherein determining patron usage comprises linking access based relationships between different patrons.

19. The method of claim 18, wherein the relationship is determined based on a patron liking a post on a social media environment by the other patron.

20. In a digital or mixed digital and physical library environment, a computing system comprising:
one or more processors;
one or more computer readable media coupled to the one or more processors, wherein the one or more computer readable media comprise computer executable instructions that then executed by one or more of the one or more processors cause one or more of the one or more processors to perform the following:
accessing information from a plurality of libraries about patron access of physical resources at the libraries;
accessing information from the plurality of libraries about patron access of electronic resources;
accessing information about the plurality of libraries; and
determining patron usage of electronic resources and/or physical resources based on library characteristics as determined from the information about the plurality of libraries.
